(19) United States
(12) Patent Application Publication
(10) Pub. No.: US 2022/0234186 A1
(43) Pub. Date: Jul. 28, 2022

(54) PUSH-ON SUPPORT MEMBER FOR FASTENING TOOLS

(71) Applicant: Black & Decker, Inc., New Britain, CT (US)

(72) Inventors: Jeffrey J. MEYER, Los Gatos, CA (US); Stuart E. GARBER, Towson, MD (US); Erin Elizabeth JASKOT, Richmond, VA (US)

(21) Appl. No.: 17/718,732

(22) Filed: Apr. 12, 2022

Related U.S. Application Data
(63) Continuation of application No. 15/195,095, filed on Jun. 28, 2016, now Pat. No. 11,325,235.

(51) Int. Cl. B25C 7/00; B25C 1/06

(52) U.S. Cl. CPC B25C 7/00; B25C 1/06

(57) ABSTRACT

A fastening tool of the present invention includes a housing having an underside. The fastening tool also includes a magazine and a support foot connected to one of the housing underside and the magazine. Using a system of cooperating detents formed on the support foot and housing underside (or magazine, as the case may be), the support foot can be quickly and easily removably secured to the fastening tool without using any tools.

### BACKGROUND OF THE INVENTION

### Field of the Invention

The present invention relates to fastening tools, and more particularly to fastening tools having support elements to orient the fastening tools to a work surface.

### Description of the Related Art

Fastening tools, such as concrete nailers, staplers and other nailers, are often equipped with various support elements to orient the fastening tools relative to a work surface. Typically the support elements are mounted on the bottom of the fastening tool magazine or on the bottom of the fastening tool housing. Some support elements are made adjustable on the fastening tool so that the fastener drive axis can be oriented at one of several different angles relative to the work surface. Others are permanently attached to a fixed location on the fastening tool, thereby yielding much less flexibility.

One major difficulty with conventional adjustable types of support elements is that they require such tools as screwdrivers and wrenches, first to remove the support element, then to move the support element from one location on the fastening tool to another, and then finally to reattach the support element to the fastening tool. That means every time it's necessary to readjust the angle of the fastening tool drive axis relative to a work surface, the operator must first reach for the necessary screwdriver or wrench, then use that tool to release the support element from, then reattach the support element to, the fastening tool. As may be imagined, the above sequence costs a considerable amount of time.

Another drawback to conventional removable support elements is that such elements involve multi-part, often elaborate, subassemblies, including, for example, swiveling mechanisms. Swiveling mechanisms necessarily make support elements more expensive and more likely to malfunction, than if it were possible to manufacture the support elements as one-piece units.

Thus, it has become apparent that what is now required is a fastening tool equipped with a removable one-piece support member or foot which requires no tools either to connect the support member to the fastening tool, or to secure the support member in place.

### SUMMARY OF THE INVENTION

Accordingly, one embodiment of the fastening tool of the present invention includes a one-piece adjustable support member or foot which can be removably attached either directly to the underside of the fastening tool, or to a fastener magazine disposed on the underside of the fastening tool, without using any tools. The support foot defines internal channels or slots which, in turn, define female detents. The channels cooperate with mating tracks or rails disposed on either the underside of the fastening tool or on the bottom of a fastener magazine, as the case may be. The tracks define male detents which cooperate with the female detents to releasably but securely retain the support foot on the fastening tool. A stop is formed at the end of the track to prevent the support foot from traveling past a desired location on the fastening tool.

To removably attach the support foot to a fastening tool, the operator need only move the support foot toward the fastening tool until an upper surface of the support foot engages a lower surface of the fastening tool. Then the operator moves the support foot along the lower surface of the fastening tool until the leading edges of the support foot proximate open ends of the channels engage the tracks. The operator then slides the support foot along the tracks until the leading edges are deflected away from respective male detents on the tracks. The operator continues to push the support foot along the tracks until the male detents become nested in the female detents. The support foot is thus releasably but securely retained at the location of the male detents, having never required the use of any tools during the entire process. (It should be noted that in this respect, if desired, the tracks can be constructed of a plastic material so that they deflect away from the leading edge of the support foot, rather than vice-versa.)

To remove the support foot, the operator need only push the support foot in the reverse direction along the tracks so that the respective detents separate, and until the support foot channels clear the tracks. Then, again without using any tools, the operator simply moves the support foot away from the fastening tool lower surface.

The support foot and fastening tool provide a fail-safe method for preventing the support foot from being attached to the fastening tool backwards, namely at an orientation other than the desired orientation of the support foot relative to the fastening tool. The channels or slots provided in the upper surface of the support foot define respective open and closed ends. If an operator moves the support foot oriented backwards so that it engages the lower surface of the fastening tool, and then attempts to engage the tracks with the support member, the closed end of the support member blocks any further movement along the lower surface of the fastening tool. Thus, the only way the support member can be attached to the tracks disposed on the fastening tool is by orienting the support member correctly relative to the fastening tool.

In another embodiment of the fastening tool of the present invention, the underside of the fastening tool or of the magazine, as the case may be, is provided with a plurality of detents on each track, corresponding to a plurality of locations along the track at which it is desired to retain the support member.

In this connection, yet another feature of the support member and fastening tool allows an operator, without using any tools, to compensate for changes in height of the contact trip occasioned by using an adjustable contact trip mechanism. If, for example, the contact trip were to be adjusted to be higher, then the contact trip drive axis would become skewed from the desired angle relative to a work surface. In the case of a concrete nailer, it is highly desirable to maintain that angle as close to 90° as possible. Accordingly, when using a mechanism to adjust the height of the contact trip (as, for example, when using differently—sized nails), the support member can simply be moved by hand from one position on the tracks determined by the location of one set of male detents, to another position determined, for example, by another set of male detents, until the support foot contacts the work surface at a location where the drive axis is once again perpendicular to the work surface.

The present invention accordingly yields a fastening tool and support foot fulfilling the need for an inexpensive, one-piece support member that can be quickly and easily attached to, and securely retained on, a fastening tool or magazine, and then quickly and easily removed, without using any tools.

### BRIEF DESCRIPTION OF THE DRAWINGS

The above-mentioned and other features and advantages of this invention, and the manner of attaining them, will become more apparent and the invention will be better understood by reference to the following description of an embodiment of the invention taken in conjunction with the accompanying drawings, wherein:

FIG. 1 is a perspective view of one embodiment of a fastening tool and support foot of the present invention.

FIG. 2 is an enlarged elevational detail view of a magazine of the fastening tool of FIG. 1.

FIG. 3 is a detail of the circled region of FIG. 2.

FIG. 4 is an enlarged partial elevational sectional view taken along line 4-4 of FIG. 1.

FIG. 5A is a perspective detail view of the support foot of the present invention.

FIGS. 5B and 5D are side elevational views of the support foot of FIG. 5A.

FIG. 5C is a top plan view of the support foot of FIG. 5A.

FIGS. 5E and 5F are elevational views taken from the rear and the front, respectively, of the support foot of FIG. 5A.

FIG. 5G is an elevational sectional view taken along line 5G-5G of FIG. 5C.

FIG. 6A is a partial exploded perspective view of the fastening tool and support foot of FIG. 1, showing an upper surface of the support foot being moved toward a lower surface of the fastening tool.

FIG. 6B is an elevational sectional detail view taken along line 6B-6B of FIG. 6A.

FIG. 7A is a view similar to that of FIG. 6A, showing the support foot being moved along tracks of the fastening tool so that leading edges of the support foot begin to deflect away from male detents formed on the tracks.

FIG. 7B is a horizontal sectional detail view taken along line 7B-7B of FIG. 7A.

FIG. 7C is a view similar to that of FIG. 6B, taken along line 7C-7C of FIG. 7A.

FIG. 8A is a view similar to that of FIG. 7A and showing the support foot having been moved on the tracks to a position where respective detents cooperate to retain the support foot in place.

FIGS. 8B and 8C are views similar to those of FIGS. 7B and 7C, respectively, but showing the support foot positioned as shown in FIG. 8A.

FIG. 9A is a partial perspective detail view of a support foot positioned on the lower surface of the fastening tool of FIG. 1, but oriented at an incorrect orientation relative to the fastening tool.

FIG. 9B is a horizontal sectional detail view taken along line 9B-9B of FIG. 9A.

FIG. 9C is a view similar to that of FIG. 9A, but showing the support foot being blocked from traveling along the tracks.

FIG. 9D is a horizontal sectional detail view taken along line 9D-9D of FIG. 9C.

FIG. 10A is a partial elevational detail view of the fastening tool and support foot of FIG. 1, where the contact trip has a height H1.

FIG. 10B is a view similar to that of FIG. 10A, but where the contact trip height has been increased to H2.

FIG. 10C is a view similar to that of FIG. 10B, showing that the support foot has been positioned on the fastening tool of FIG. 1 to compensate for the change in height of the contact trip.

FIG. 11A is an enlarged elevational detail view of the lower surface of a second embodiment of the fastening tool of the present invention.

FIG. 11B is a horizontal sectional view taken along the line 11B-11B of FIG. 11A, but showing the support foot attached to the fastening tool.

FIG. 12 shows another embodiment of a fastening tool and support foot of the present invention, in which the support foot is mounted directly upon a lower surface of the fastening tool housing.

Corresponding reference characters indicate corresponding parts throughout the several views. The exemplifications set out herein illustrate embodiments of the present invention, and such exemplifications are not to be construed as limiting the scope of the present invention in any manner.

### DETAILED DESCRIPTION OF THE INVENTION

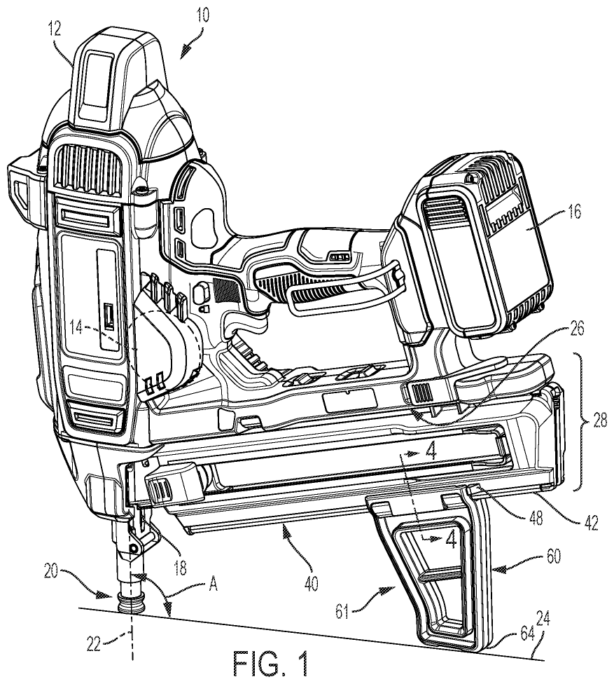

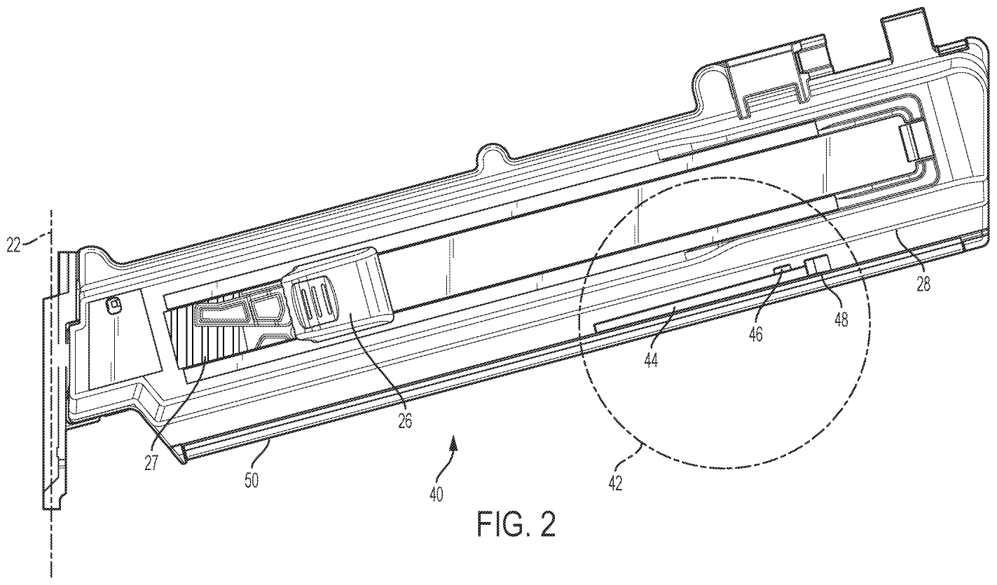

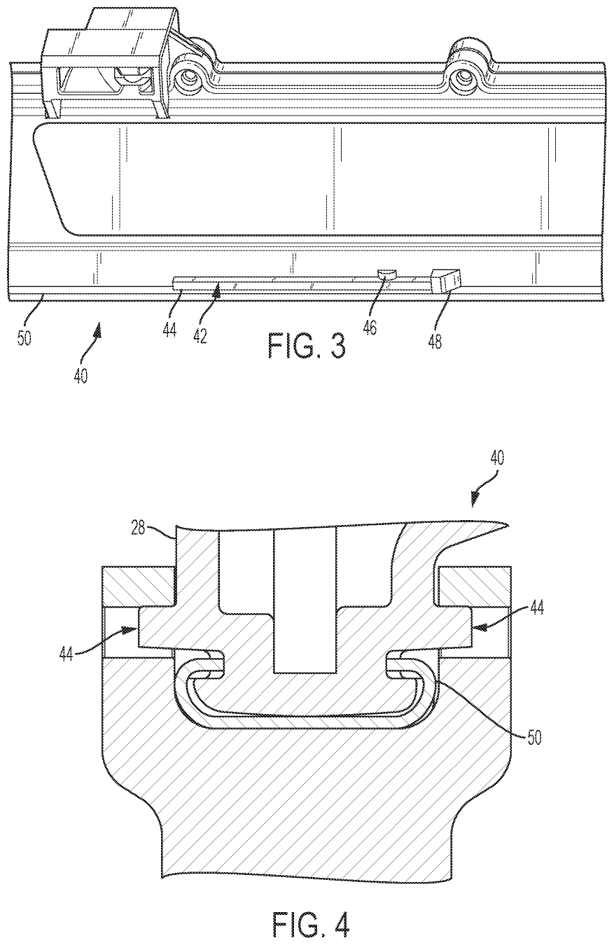

Referring now to the drawings and particularly to FIG. 1, a fastening tool 10 in accordance with an embodiment of the present invention includes a housing 12, a motor 14 (shown in phantom) disposed in the housing, a battery pack 16 for providing power to the motor, and a drive system including a drive bar (not shown) configured for driving a fastener and being operatively associated with the motor, such as, for example, by use of a flywheel. The drive system further includes a drive track 18 and a contact trip 20, disposed along a drive axis 22, which is oriented at a desired angle A relative to a work surface 24.

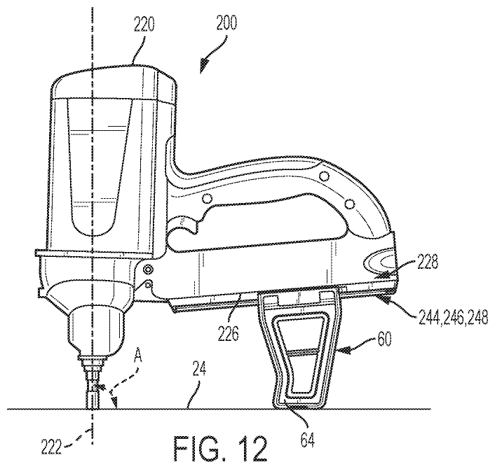

Continuing to refer to FIG. 1, a fastener magazine 40 is attached to an underside 26 of the housing 12, and a support member or foot 60 of the present invention is removably attached to the magazine. Although the fastening tool 10 is depicted as having a magazine 40 to which the support foot 60 is attached, it is important to note that the support foot may also be directly attached to the underside 26 of the fastening tool, in the event the fastening tool does not have a magazine, or in the event that the fastening tool magazine is disposed in a location on the housing 12 other than at the underside. Such an embodiment of the fastening tool 200 is shown in FIG. 12. Consequently, for the purposes of this description, a “lower surface” 28 of the fastening tool 10 is defined generally to include not only the underside 26 of housing 12, but also to include the magazine 40, so that it can be seen that the support foot 60 is readily usable with either type of fastening tool (see bracketed region 28 in FIG. 1).

As is also shown in FIG. 1, one purpose of the support foot 60 is to maintain a desired orientation of the fastening tool drive axis 22 at an angle A with a work surface 24. Accordingly, it should also be noted that, although an embodiment of the present invention is described in connection with an electric-powered concrete nailer, the magazine 40 and support foot 60 may be used with any type of fastening tool, including without limitation staplers and other nailers. Furthermore, such fastening tools may use other types of drive systems, including without limitation hydraulic, pneumatic, combustion/gas, and explosive/powder-actuated systems. Therefore, regardless of the type of fastening tool, the magazine 40 and support foot 60 will be operative to maintain the desired orientation at an angle A.

Now referring to FIGS. 1- 3, the magazine 40 is configured to hold nails 27 oriented in parallel with the drive axis 22, and defines an engagement portion 42 of the lower surface 28 that cooperates with the support foot 60 to retain the support foot on the fastening tool 10. The engagement portion 42 includes a track 44 disposed on each side of the magazine 40, each track defining a male detent 46 and a stop 48. As shown in FIG. 4, magazine 40 is also equipped with a retaining guard 50.

FIG. 1 shows the support foot 60 disposed on the track 44 so that the support foot engages the stop 48. At this location of the support foot 60 on the lower surface 28, various elements of the support foot and the magazine 40 cooperate to releasably retain the support foot in the position shown in FIG. 1. This cooperation maintains the orientation of the fastening tool drive axis 22 at the angle A relative to work surface 24.

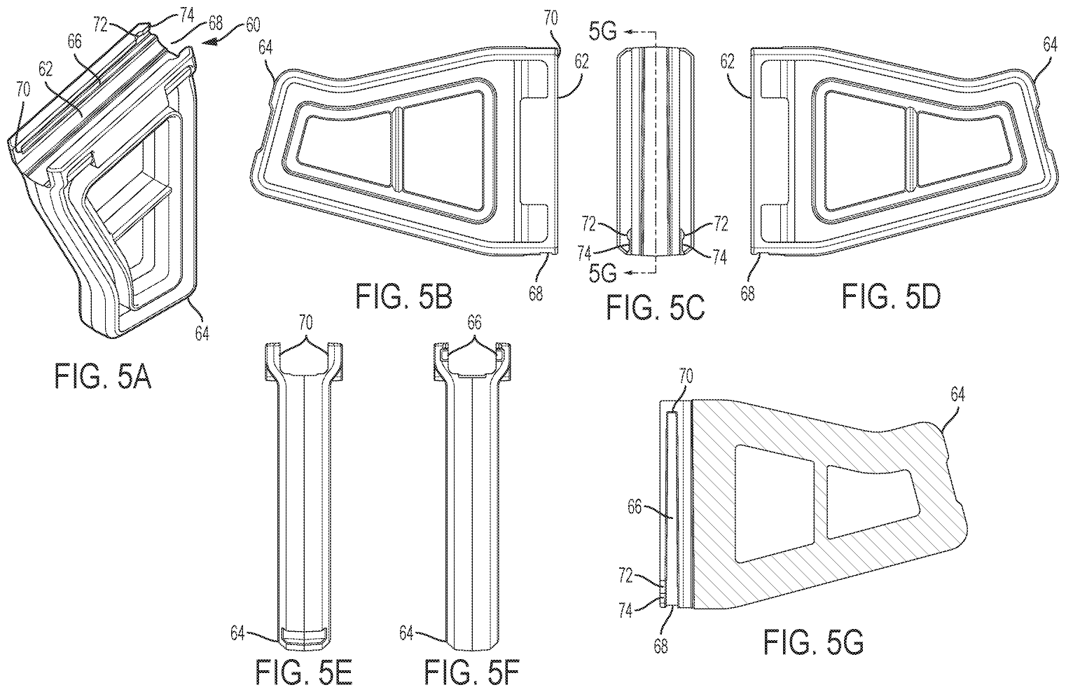

FIGS. 5A-5G detail the features of the support foot 60, which defines an upper surface 62 and a work surface-engaging portion 64 disposed at the bottom of the support foot. The upper surface 62 in turn defines two opposed parallel slots or channels 66, each having an open front end 68 and a closed rear end 70 (FIG. 5G). The upper surface 62 further defines two opposed female detents 72 and a leading edge 74. In one embodiment of the support foot 60, the support foot is manufactured from glass-filled nylon so that the support foot has a slight amount of resiliency.

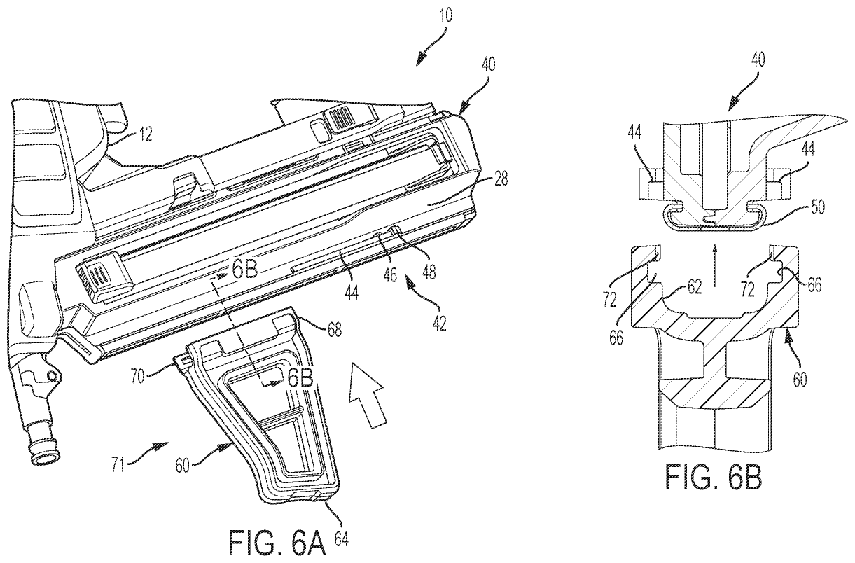

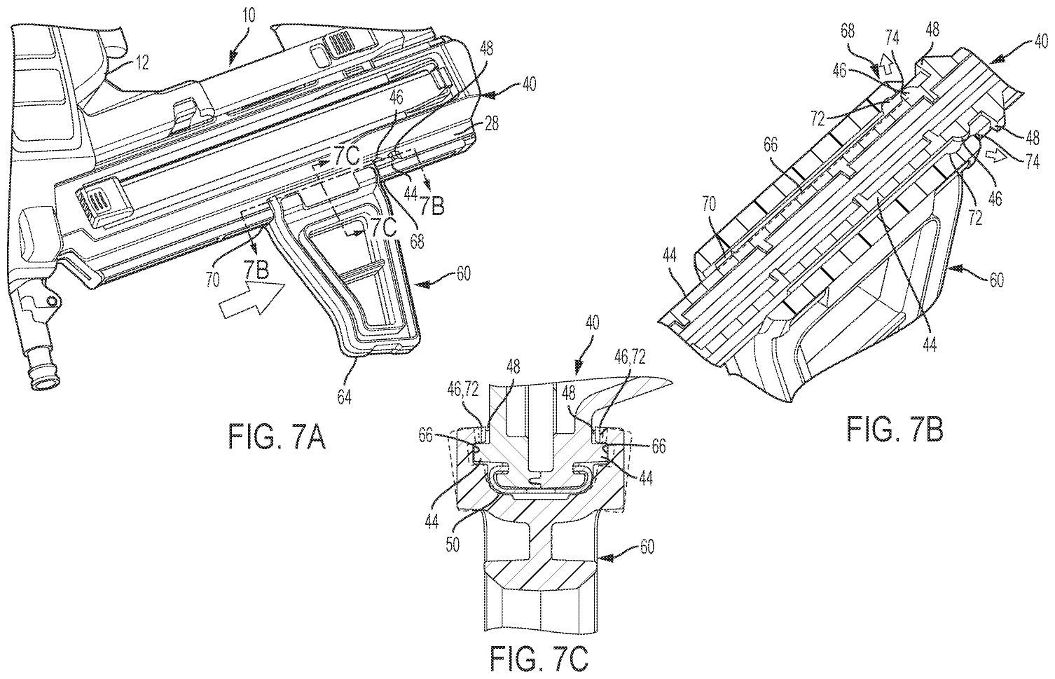

A method of releasably attaching the support foot 62 to the lower surface 28 of the fastening tool 10 is illustrated in FIGS. 6A through 8C. The support foot 60, oriented at a desired orientation 71 relative to the fastening tool 10, is moved toward the magazine 40, as shown in FIGS. 6A and 6B, so that the upper surface 62 of the support foot engages the lower surface 28 of the fastening tool. Then, as shown particularly in FIG. 7A, the support foot 60 is moved along the lower surface 28 until respective channels or slots 66 in the support foot engage corresponding tracks 44 on the lower surface. The fastening tool operator continues to move the support foot 60 in the direction shown by the arrow in FIG. 7A until male detents 46 cause the leading edges 74 of the support foot to deflect slightly away from the male detents 46, as shown by the arrows in FIG. 7B, and by the phantom line positions of the support foot in FIG. 7C.

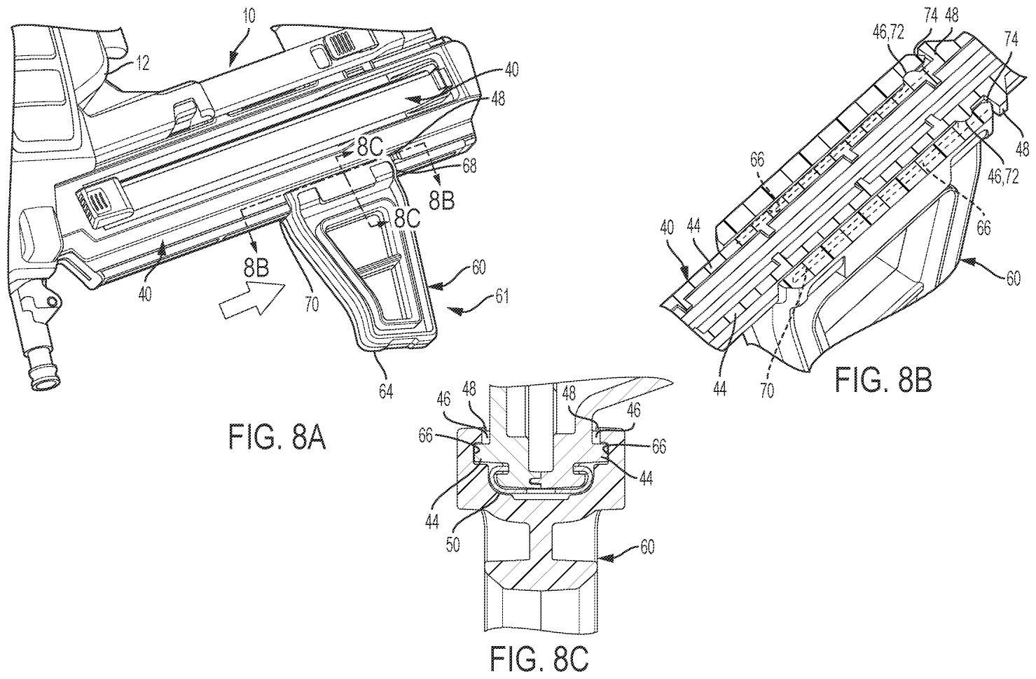

As shown in FIGS. 8A through 8C, the fastening tool operator continues to slide the support foot 60 along the track 44 until respective male detents 46 become nested in their corresponding female detents 72. Stops 48 may also engage respective leading edges 74 of the support foot 60 to prevent the support foot from traveling past the position shown in FIG. 8B. It should be noted that, in one embodiment of the present invention, the magazine 40 is manufactured from glass-filled polypropylene. Consequently the process depicted so far shows the support foot 60 deflecting away from detents 46 formed on the magazine 40. However, if desired, the magazine can be manufactured so that a portion of the magazine, namely, the male detents 46, deflect inwardly away from the leading edges 74 of the support foot, instead. In this case, for example, the magazine detents may be formed of a suitable plastic such as DELRIN® plastic, or nylon without glass fill.

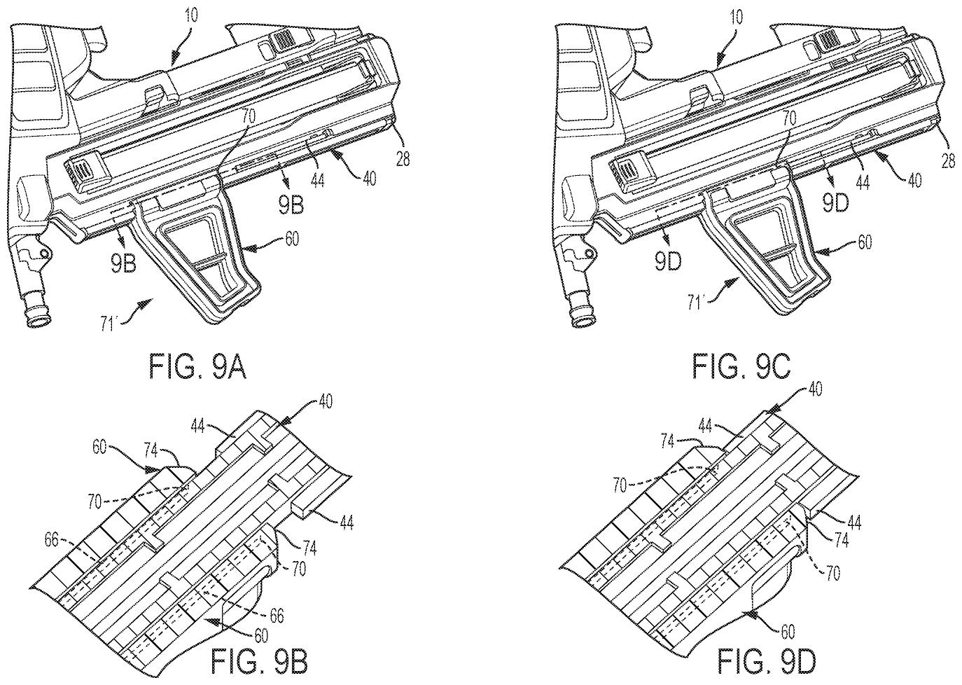

The support foot 60 is prevented from being attached to the lower surface 28 backwards. In this event, when the support foot 60 is positioned against magazine 40 at an incorrect orientation 71′, as illustrated in FIGS. 9A-9D, such that the closed rear end 70 of the support foot is placed closer to the tracks 44 than the open front end 68 of the support foot, the closed front end is blocked by the tracks (see FIGS. 9B and 9D). This prevents the support foot 60 from being moved along the tracks 44, and thus prevents the support foot from being attached to the lower surface 26 of the fastening tool 10 at the incorrect orientation 71′ (namely, backwards).

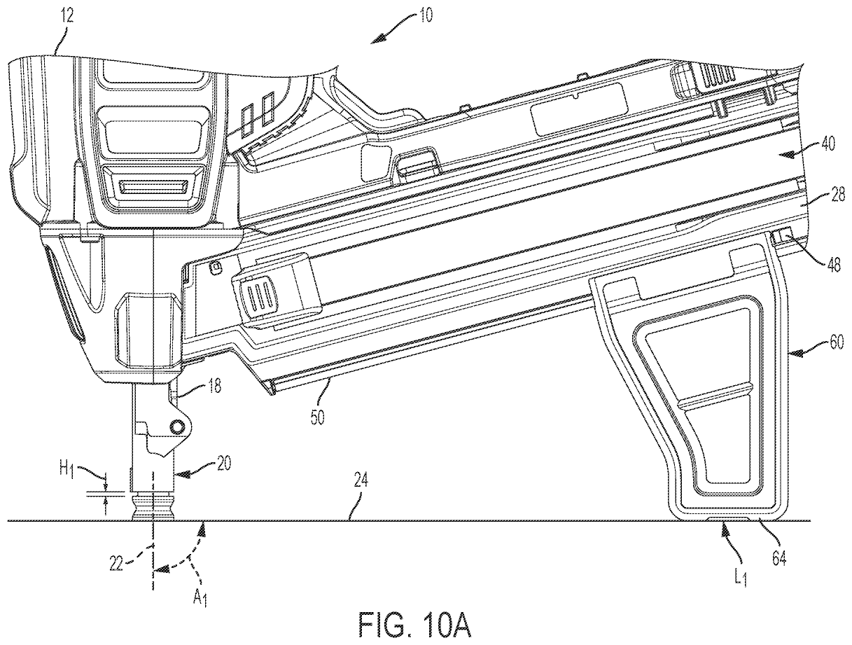

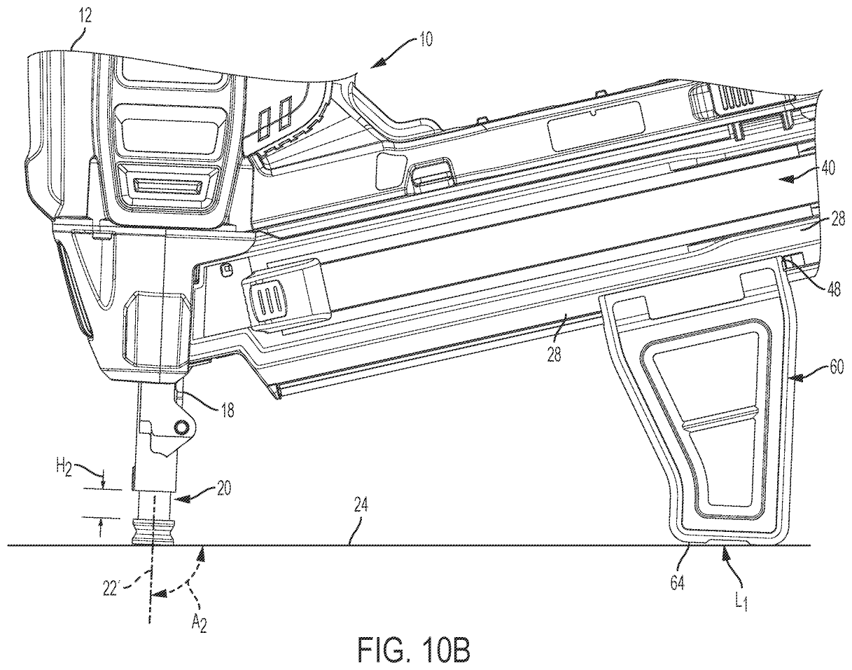

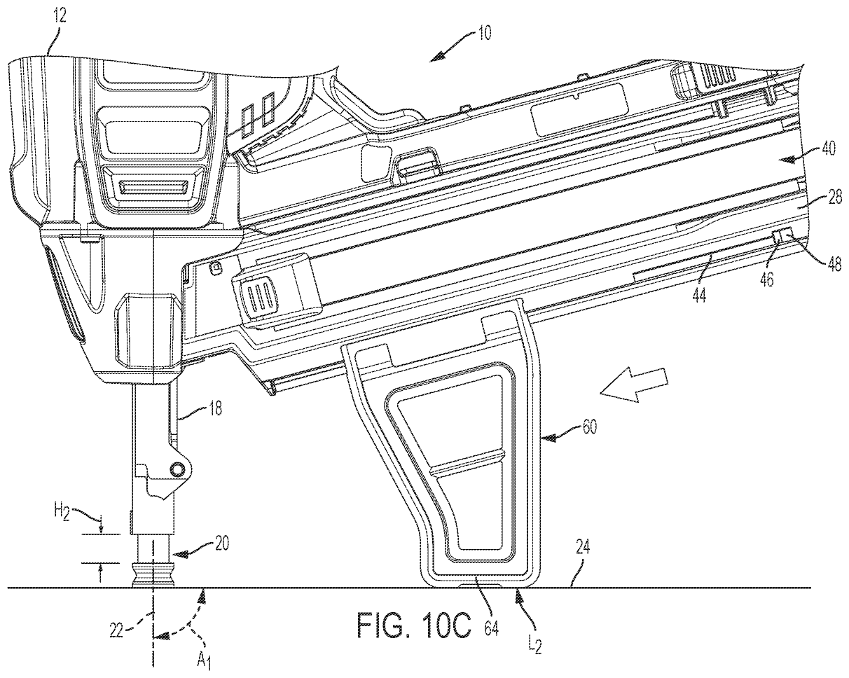

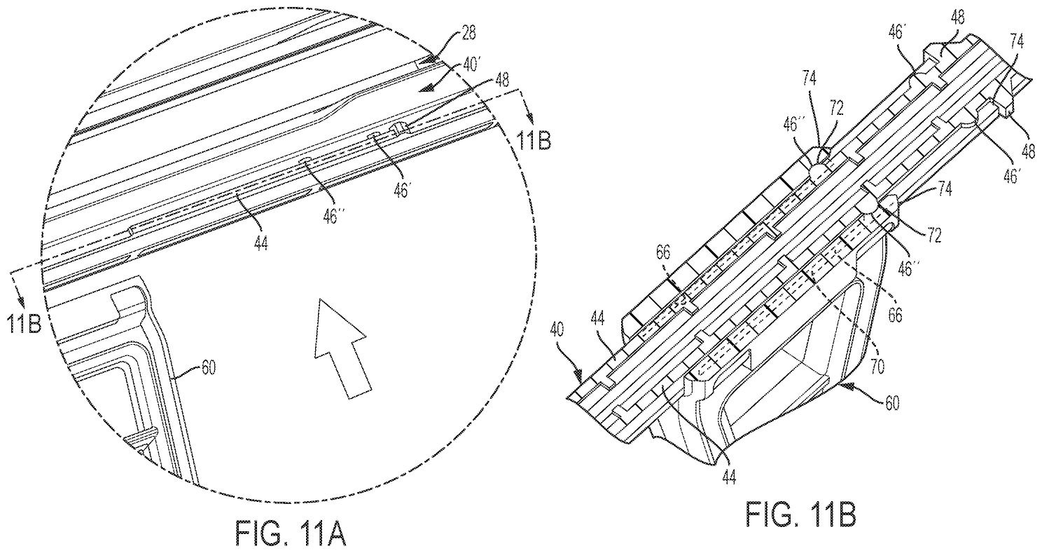

FIGS. 10A-10C illustrate a method for compensating for the use of a height-adjustment system to change the height of the contact trip 20 relative to the work surface 24. FIG. 10A shows the angle A1 of the drive axis 22 when the height of the contact trip is set at H1, and when the location of the work surface-engaging portion 64 of the support foot 60 is at L1. If the contact trip height is increased to H2, as shown in FIG. 10B, the drive axis 22′ becomes skewed to form a different angle A2 relative to the work surface 24. Also, a portion of the work surface-engaging portion 64 is lifted slightly off the work surface 24. To compensate for the increase in contact trip height, and to bring the angle of the drive axis 22′ relative to the work surface 24 back to angle A1, the fastening tool operator merely moves the support foot 60 by hand along the tracks 44 in a first direction shown by the arrow in FIG. 10C, until the respective male and female detents 46, 72 are disengaged. The operator then continues to move the support foot 60 along the lower surface 28 until the support foot reaches a location L2 where the work surface-engaging portion 64 of the support foot engages the work surface 24, such that the drive axis 22 is oriented once again at angle A1.

If it is desired to retain the support foot 60 at the position shown, for example, in FIG. 10C, the lower surface 28 of the fastening tool 10 may be modified as shown in FIGS. 11A and 11B. Here the magazine 40′ now defines first and second male detents 46′, 46″ which cooperate with the female detents 72 of the support foot 60, in the same manner as is shown in FIG. 8B when a single set of male detents 46 are used, so that the support foot can be retained at two different locations relative to the fastening tool 10. Using no tools, the operator merely moves the support foot 60 as shown by the arrow in FIG. 11A so that the support foot engages the lower surface 28 (in this case, of magazine 40′), then moves the support foot along the lower surface until the support foot engages the track 44, as was previously described. The operator then slides the support foot 60 along the track 44 until the support foot is retained in place either by male detents 46′ or by male detents 46″. To remove the support foot 60, the operator simply reverses the process. The operator, using hand pressure only, simply slides support foot 60 in the opposite direction along the tracks 44 until the support foot is disengaged from the male detents 46′, 46″. Then, the operator continues to move the support foot 60 until the support foot clears the tracks 44. At that point, all the operator has to do is move the support foot 60 away from the lower surface 28 of the fastening tool 10. Of course, if desired, more than two detents 46 may be used.

The support foot 60 may also be mounted directly to a lower surface 228 of another embodiment of the fastening tool 200 of the present invention, as shown in FIG. 12. Here, fastening tool 200 includes a housing 220 which defines an underside 226, upon which are formed tracks 244, detents 246, and stops 248, which are configured similarly to their respective counterparts 44, 46 and 48 previously described. The support foot 60 thus similarly maintains a drive axis 222 oriented at a desired angle A relative to the work surface 24.

It can now be seen that various embodiments of the fastening tool, magazine and support foot of the present invention fulfill the need for an inexpensive system for easily but securely attaching a support foot to a fastening tool, so that the support foot can be removably retained at a desired location on the fastening tool, all without the use of any tools whatsoever.

While the present invention has been described with respect to various embodiments, the present invention may be further modified within the spirit and scope of this disclosure. This application is therefore intended to cover any variations, uses, or adaptations of the present invention using its general principles. Further, this application is intended to cover such departures from the present disclosure as come within known or customary practice in the art to which this invention pertains and which fall within the limitations of the appended claims.

1. A method of removably attaching a support foot to a lower surface of a fastening tool, comprising:
moving the support foot toward the fastening tool so that the support foot engages the lower surface; and
deflecting a portion of the support foot over a portion of the lower surface.

2. The method claimed in claim 1, wherein the support foot is a single unitary member.

3. The method claimed in claim 1, wherein the support foot is retained on the lower surface of the fastening tool without using any tools.

4. The method claimed in claim 1, wherein only the support foot and the lower surface are needed to retain the support foot on the fastening tool.

5. The method claimed in claim 1, wherein, other than the support foot, there are no moving parts required to retain the support foot on the fastening tool.

6. The method claimed in claim 1, further comprising:
prior to the deflecting step, moving the support foot along the lower surface of the fastening tool until the support foot reaches a desired position relative to the fastening tool.

7. The method claimed in claim 6, further comprising:
moving the support foot along the lower surface of the fastening tool so that the support foot and the portion of the lower surface of the fastening tool cooperate to attach and retain the support foot in the desired position.

8. The method claimed in claim 7, wherein the support foot and the portion of the lower surface of the fastening tool each define a detent, and
wherein the respective detents cooperate to retain the support foot in the desired position.

9. The method claimed in claim 8, wherein a portion of the support foot deflects to permit the support foot to ride over the detent formed on the portion of the lower surface of the fastening tool.

10. The method claimed in claim 9, further comprising:
limiting the distance that the support foot can be moved along the lower surface of the fastening tool.

11. The method claimed in claim 7, further comprising:
preventing the support foot from being attached to the fastening tool at an incorrect orientation.

12. The method claimed in claim 1, wherein the lower surface of the fastening tool defines two opposing tracks, and
wherein the support foot defines two opposing channels operatively associated with respective opposing tracks.

13. The method claimed in claim 12, further comprising:
moving the support foot in a first direction along the lower surface of the fastening tool; and
engaging the channels with respective tracks.

14. The method claimed in claim 13, wherein the tracks define at least one male detent, and
wherein the channels define at least one female detent that cooperates with the at least one male detent to releasably retain the support foot on the tracks at a desired location.

15. The method claimed in claim 14, wherein a plurality of male detents are formed at locations along each track, so that the support foot may be retained at a plurality of locations on the tracks corresponding to the locations of the plurality of male detents.

16. The method claimed in claim 14, further comprising:
moving the support foot in a second direction, opposite to the first direction, along the tracks so that the at least one female detent is disengaged from the at least one male detent;
continuing to move the support foot along the lower surface of the fastening tool until the channels clear the tracks; and
moving the support foot away from the fastening tool.

17. A method of removably attaching a support foot to a lower surface of a fastening tool, comprising:
moving the support foot toward the fastening tool so that the support foot engages the lower surface; and
deflecting a portion of the lower surface over a portion of the support foot.

18. A method of maintaining a desired angle of the drive axis of a fastening tool relative to a work surface, comprising:
engaging a one-piece support member with a lower surface of the fastening tool, the support member also being engageable with the work surface;
moving the one-piece support member along the lower surface of the fastening tool until the desired angle is reached when the support member engages the work surface;
wherein no tools are required to effect the engaging and moving steps; and
wherein the one-piece support member is free of movable parts, other than the one-piece support member itself, in the engaging and moving steps.

19. The method claimed in claim 18, wherein the support member is retained on the lower surface of the fastening tool without tools when the desired angle of the drive axis is reached.

20. The method claimed in claim 18, further comprising:
providing cooperating detents on the support member and on the fastening tool so that the support member is retained on the lower surface of the fastening tool when the desired angle of the drive axis is reached.

21-28 (canceled)
